(19) United States
(12) Patent Application Publication
(10) Pub. No.: US 2022/0005090 A1
(43) Pub. Date: Jan. 6, 2022

(54) CAR SHARING FEE SYSTEM

(71) Applicant: Toyota Jidosha Kabushiki Kaisha, Toyota-shi Aichi-ken (JP)

(72) Inventors: Masahiro Nishiyama, Toyota-shi (JP); Kenji Tsukagishi, Toyota-shi (JP); Takahisa Kaneko, Toyota-shi (JP); Erina Kigoshi, Tokyo-to (JP); Aiko Miyamoto, Toyota-shi (JP)

(21) Appl. No.: 17/360,620

(22) Filed: Jun. 28, 2021

(30) Foreign Application Priority Data
Jul. 6, 2020 (JP) 2020-116584

(51) Int. Cl. G06Q 30/02; B60L 53/66; B60L 58/12

(52) U.S. Cl. CPC G06Q 30/0283; B60L 58/12; B60L 53/665

(57) ABSTRACT

A car sharing fee system for calculating a car sharing fee for an electric vehicle is provided. In the car sharing fee system, the car sharing fee is discounted when the electric vehicle is recharged by a user. A discount is designed to motivate the user to recharge an on-board battery.

### CROSS REFERENCE TO RELATED APPLICATION

This application claims priority to Japanese Patent Application No. 2020-116584 filed on Jul. 6, 2020, which is incorporated herein by reference in its entirety including the specification, claims, drawings, and abstract.

### TECHNICAL FIELD

The present disclosure relates to a car sharing fee system for calculating a usage fee (car sharing fee) for a car sharing service.

### BACKGROUND

Car sharing services for shared use of a vehicle which is not a private vehicle owned by an individual have come into widespread use. Typically, in such a car sharing service, a service company which provides a car sharing service prepares a vehicle, while a user operating a vehicle lent by the service company pays a fee for the use of the vehicle to the service company. It should be noted that car sharing service encompasses a service referred to as a car rental service.

Typically, such services require that, in principle, gasoline powered vehicles (including diesel vehicles and the like) should be returned with a full fuel tank. If the vehicle is returned with a fuel tank that is not full, a gasoline fee is calculated based on a traveled distance or a difference between the amount of gasoline remaining in the fuel tank and the full capacity of the fuel tank, and is charged to a user of the car sharing service. On the other hand, for hybrid electric vehicles (HEVs) and battery electric vehicle (BEVs), it is necessary that the state of charge (SOC) of an on-board battery should be considered in a usage fee of the service, with respect to which a variety of suggestions have been made.

JP 2018-090153 A describes that an SOC restoration process for returning the SOC to its initial value as identified at the start of use is performed when a destination approaches during travel in a car share mode of an HEV. As a result, the HEV can be returned at the destination with the SOC restored to the condition established at the start of use.

On the other hand, JP 2019-087041 A describes, as a fee charging scheme for a car sharing service for BEVs, both a fixed plan in which the fee is charged without taking into account SOC changes and an SOC indexed plan in which the fee is based on the amount of electricity used (a usage based SOC rate). JP 2019-087041 A further describes that the usage based rate is reduced when the SOC at return of the BEV is within a range deemed appropriate (of SOCs from 30% to 70%, for example). In this way, the fee can be charged taking into account an amount of electricity recharged to an on-board battery.

### CITATION LIST

### Patent Literature

Patent Document 1: JP 2018-090153 A

Patent Document 2: JP 2019-087041 A

Here, various parking lots and highway service areas, for example, are equipped with recharging facilities which can be used for recharging an on-board battery mounted on a vehicle. In the above-described conventional techniques, promoting an action of recharging the on-board battery of the vehicle is not sufficiently contemplated.

### SUMMARY

The present disclosure discloses a car sharing fee system for calculating a fee for operating a shared electric vehicle (“car sharing fee”), the car sharing fee system being configured to discount the car sharing fee when the electric vehicle is recharged by a user.

In an aspect of the disclosure, the car sharing fee system may include a recharging operation storage configured to store at least one of an amount of recharged electricity and a length of recharging time, and may be configured to discount the car sharing fee based on the at least one of the amount of recharged electricity and the length of recharging time.

In another aspect of the disclosure, the car sharing fee system may include a travel distance storage configured to store a travel distance, and a recharged amount calculator configured to estimate from the travel distance a present state of charge that is expected to be found when no recharging operation is performed, and calculate the amount of recharged electricity from a difference between the expected present state of charge and an actual state of charge. The thus-configured car sharing fee system may be configured to discount the car sharing fee based on the calculated amount of recharged electricity.

In another aspect of the disclosure, the car sharing fee system may be configured to discount the car sharing fee when the amount of recharged electricity found at return of the electric vehicle is in a predetermined range.

In another aspect of the disclosure, the car sharing fee system may be configured to discount the car sharing fee when the electric vehicle is recharged to a predetermined state of charge.

In another aspect of the disclosure, the car sharing fee system may be configured to change a rate of discounting the car sharing fee depending on a time period in which a recharging operation is performed.

In another aspect of the disclosure, the car sharing fee system may include an output unit configured to notify information about a discount on the car sharing fee.

According to the present disclosure, the car sharing fee is discounted when a user performs a recharging operation. Therefore, the user is motivated to perform the recharging operation, which can, in turn, leads to the on-board battery being maintained in a favorable state and be ready for next use.

### BRIEF DESCRIPTION OF DRAWINGS

Embodiments of the present disclosure will be described based on the following figures, wherein:

FIG. 1 is a diagram for explaining an overall configuration of a car sharing service;

FIG. 2 is a block diagram showing a configuration of an electric vehicle 10;

FIG. 3 is a block diagram showing a general configuration of a management computer 18;

FIG. 4 is a block diagram showing a configuration of a user terminal 22;

FIG. 5 is a flowchart showing a procedure to offer a recharge point; and

FIG. 6 is a flowchart for explaining navigation to a recharging facility.

### DESCRIPTION OF EMBODIMENTS

Hereinafter, embodiments according to this disclosure will be explained with reference to the drawings. It should be noted that the present disclosure is not limited to any embodiments described herein.

### Configuration of Car Sharing Service

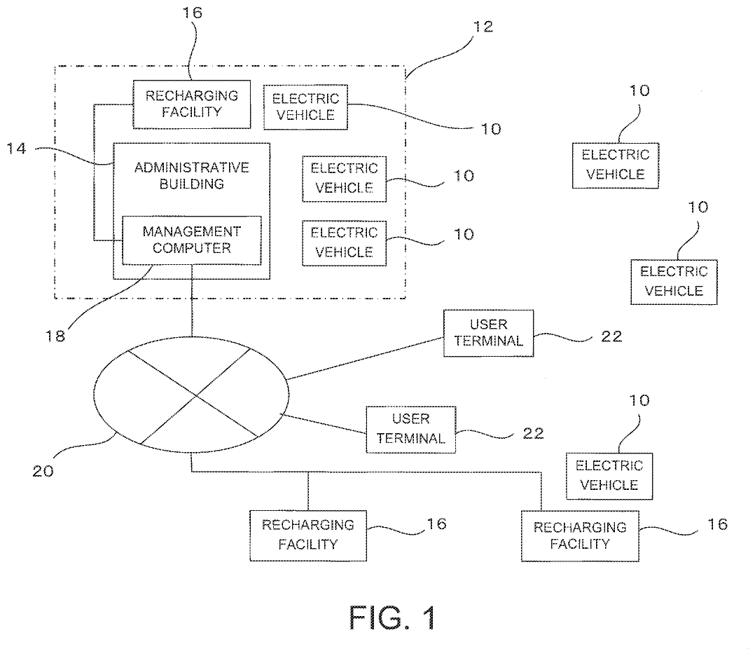

FIG. 1 is a diagram for explaining an overall configuration of a car sharing service. A service providing company owns an electric vehicle 10 to be used for the car sharing service, and operates a service establishment 12 where the electric vehicle 10 is lent and returned. In this example, the service establishment 12 includes, in addition to a parking space, an administrative building 14 and a recharging facility 16. Typically, the service providing company owns two or more electric vehicles 10 for responding to demand from two or more users.

The administrative building 14 in the service establishment 12 is equipped with a management computer 18 which is configured to perform processing to manage the electric vehicles 10, such as a process of lending the electric vehicle 10, and a process of accepting a return of the electric vehicle 10, and to perform processing for charging a service fee, for example. The management computer 18 is connected to the recharging facility 16 within the service establishment 12. Further, the management computer 18 may be configured to directly communicate with the electric vehicle 10. Alternatively, the above-described processing performed in the management computer 18 may be performed by, for example, an external server computer that manages a plurality of service facilities 12.

The management computer 18 is connected to a communication network 20 to which an external recharging facility 16 and user terminals 22 are connected. The external recharging facility 16 may include those provided at highway service areas, at establishments such as convenience stores, and on private property such as individual homes.

There are various types of recharging facilities 16. For example, an AC power supply may be utilized for a power supply of the recharging facility 16, including a single-phase 200 V AC power supply, a three-phase 200 V AC power supply, and a single-phase 100 V AC power supply, while a power supply which outputs direct current may also be utilized. For example, in a quick recharging facility, three-phase 200 V AC power can be converted into DC power which is output to allow recharging with DC power of approximately 50 kW, while in a normal recharging facility, single-phase AC power of 200 V or 100 V can be output. In a case where AC power is output, the output AC power can be converted into DC power in a battery charger mounted on the vehicle and used for recharging an on-board battery.

The user terminal 22 is a computer operated by a user of the car sharing service, and may be implemented by a personal computer, a smart phone, or the like.

The car sharing service as used herein is based on the premise that a single electric vehicle 10 is not exclusively used by an owner thereof, but is made available for shared use by multiple users, and a fee of using the electric vehicle 10 is charged to the user. Thus, the car sharing service includes a car rental service.

In the thus-defined car sharing service, a user who wishes to use the electric vehicle 10 carries out a car rental process by the user terminal 22. Alternatively, the user may visit the service establishment 12 to carry out the car rental process at the service establishment 12. It should be noted that in a procedure for using the electric vehicle 10, necessary items of information, such as a driver's license, are confirmed.

After the necessary confirmation for using the service is completed, the user goes to the service establishment 12 or another designated site and rents the electric vehicle 10 to be used. Then, the user drives the electric vehicle 10 as desired, and returns the electric vehicle 10 to the service establishment 12 (or other designated site) at the end of driving. Here, necessary data, such as vehicle identification information, start of use, end of use, and a travel distance, are entered into the management computer 18 where the fee is calculated. When the user pays the calculated fee, one use of the service is complete. It should be noted that calculation of the fee and other processes may be performed in the electric vehicle 10, and a variety of payment methods, such as credit card payment, may be used for paying the fee.

### Configuration of Electric Vehicle

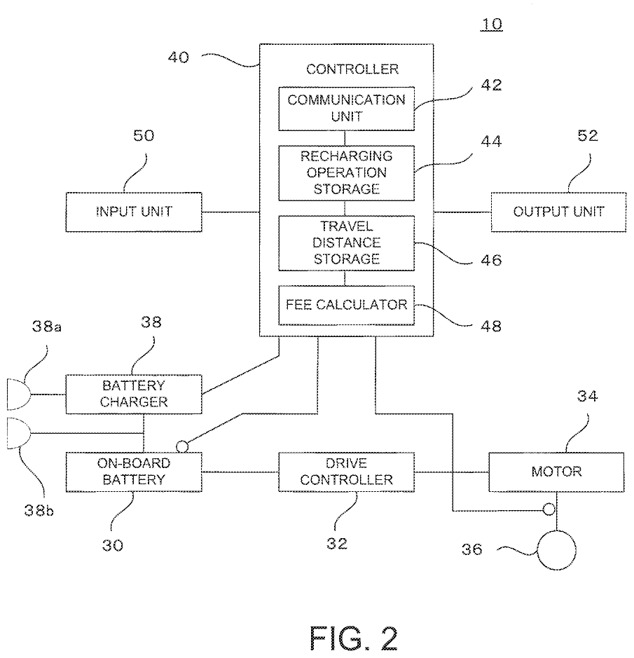

FIG. 2 is a block diagram showing a configuration of the electric vehicle 10. The electric vehicle 10 includes an on-board battery 30 whose power is supplied through a drive controller 32 to a motor 34. A drive shaft of the motor 34 is mechanically connected to a wheel 36, and rotation of the wheel 36 causes the electric vehicle 10 to travel. For example, the drive controller 32 may include an inverter, and the motor 34 may be a permanent magnet motor. Further, the electric vehicle 10 is equipped with a battery charger 38. The battery charger 38 can receive power supplied from an external power source, and charge the on-board battery 30 with the power. For the on-board battery 30, a secondary battery, such as a lithium-ion battery, is employed. Meanwhile, AC power supplied through a charging connector 38a is converted into predetermined DC power by the battery charger 38, and the converted DC power is supplied to the on-board battery 30. On the other hand, DC power supplied through a charging connector 38b is directly supplied to the on-board battery 30 without being converted.

The electric vehicle 10 may be a battery electric vehicle (BEV) which is not equipped with an engine, or may be a hybrid electric vehicle (HEV) which is equipped with an engine and able to use engine power for driving the HEV or use electric power generated by the engine for charging the on-board battery 30.

The electric vehicle 10 has a controller 40. The controller 40 controls switching of the inverter in the drive controller 32, for example, based on information, such as an accelerator input, in order to control output of the motor 34.

The controller 40 also has a function used for a car sharing service, and includes a communication unit 42, a recharging operation storage 44, a travel distance storage 46, and a fee calculator 48. The communication unit 42 is connected via a communication network 20 to the management computer 18, and may be connected to other devices. The communication unit 42 is therefore able to establish various types of communication.

The recharging operation storage 44 stores information about an operation to recharge the on-board battery 30. In this example, the recharging operation storage 44 stores data on an amount of recharged electricity and a length of recharging time which are obtained based on information from the battery charger 38. Further, the recharging operation storage 44 also stores information about a state of charge (SOC) of the on-board battery 30. The SOC is calculated from a voltage of the on-board battery 30, an amount of recharged and discharged currents, and other values. The travel distance storage 46 detects a travel distance of the electric vehicle 10 from a rotation speed of an axle.

The fee calculator 48 calculates the car sharing fee from the start to the end of the car sharing service. The controller 40 is also supplied with signals indicative of the start and the end of the car sharing service, while the recharging operation storage 44 and the travel distance storage 46 can store data about a recharging operation performed after the start of the car sharing service and the distance traveled after the start of the car sharing service, respectively. In particular, the fee calculator 48 in this example has a function of predicting the fee at any time during the use of the car sharing service. For example, when a user specifies a destination and a stopover in addition to a return route to the service establishment 12 by a navigation device, it is possible to calculate the fee to be charged to the user. Particularly, in this case, it is also possible to calculate the fee while taking into account use of the recharging facility 16.

Meanwhile, the controller 40 is connected to an input unit 50 and an output unit 52. Thus, various data items and instructions can be input through the input unit 50, while various data items can be displayed on the output unit 52. It should be noted that the output unit 52 may include a display, such as a liquid crystal display or an organic EL display, while the input unit 50 may include a touch panel.

### Configuration of Management Computer

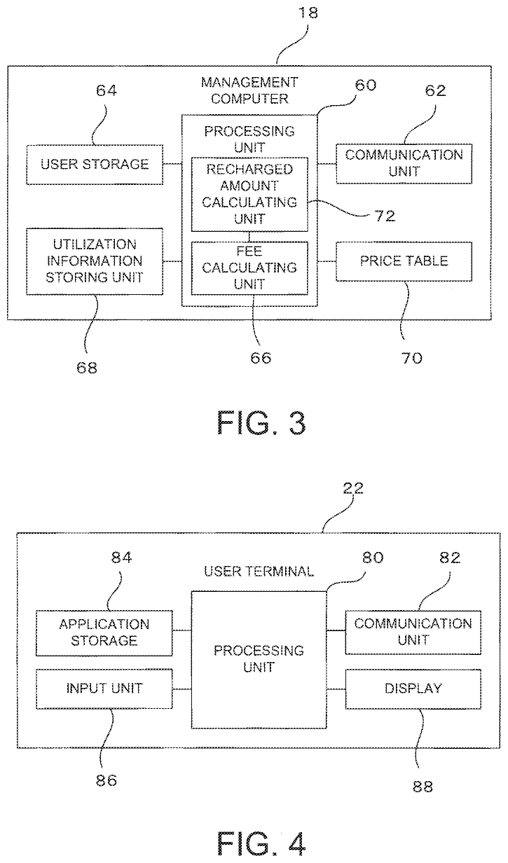

FIG. 3 is a block diagram showing a general configuration of the management computer 18. Typically, the management computer 18 is composed of a general-purpose computer. A processing unit 60 is configured to perform various calculations, and is connected to a communication unit 62. The communication unit 62 is configured to establish various communication through the communication network 20. The processing unit 60 is also connected to a user storage 64 which stores data on users of the car sharing service. In general, user registration is performed for the first use, and predetermined data (user information) is input for the registration. After this, the user information can be retrieved by a user ID, for example, to avoid duplicate input of data in subsequent use. Meanwhile, user information of a one-time user is also stored.

The processing unit 60 is equipped with a fee calculating unit 66 in which a user fee for the car sharing service is calculated. The fee calculating unit 66 is connected to a utilization information storing unit 68 and a price table 70, and is configured to calculate the fee with reference to data stored in the utilization information storing unit 68 and the price table 70. In addition, a recharged amount calculating unit 72 is configured to predict from the travel distance a value of the SOC that is expected to be of a present SOC when no recharging operation is performed, and calculate the amount of recharged electricity based on a difference between the expected present SOC and an identified actual SOC. For example, at the time of return of the electric vehicle 10 (when use of the electric vehicle 10 is finished), the recharged amount calculating unit 72 acquires the travel distance of the electric vehicle 10 and the expected present SOC. The SOC at the start of use of the electric vehicle 10 may be acquired from the electric vehicle 10 or stored in the management computer 18. Because a travel distance per electric charge (Ah: ampere hour) can be determined with a certain degree of accuracy, a total value for consumption of electric charge which is consumed depending on the travel distance can be estimated accordingly. Then, the amount of recharged electricity can be found by comparing the estimated consumption of electric charge with a change between the SOC values at the start of use and at the end of use.

It should be noted that the management computer 18 is connected to an input device, such as a keyboard, and an output device, such as a display and a printer, which are not illustrated in FIG. 3.

### User Terminal

The user terminal 22 may be a portable terminal, such as a smart phone, while a personal computer (PC) or the like may be used as the user terminal 22. FIG. 4 is a block diagram showing a configuration of the user terminal 22. As can be seen from FIG. 4, the user terminal 22 includes a processing unit 80 in which various type of data processing is performed. A communication unit 82 is connected to the management computer 18 and other units via the communication network 20 by wireless communication or a portable telephone channel. The processing unit 80 is connected to an application storage 84 in which various application programs (applications) are stored. An application for managing the car sharing service is also stored in the application storage 84. Further, the processing unit 80 is also connected to an input unit 86 and a display 88 to enable input and display of various data items. User registration and a reservation for the car sharing service may be performed by executing the car sharing application and entering predetermined inputs.

### User Registration/Download of Application

To use the car sharing service, user registration is typically carried out. In this case, a browser in the user terminal 22 is used for inputting a predetermined URL to access a website of the car sharing service. The website is operated by the management computer 18. Here, an electronic application for the car sharing service may be downloaded at the first access, or alternatively such a registration process may be designed to be completed online through the website using the browser without downloading an application.

In a case where an application is downloaded, the user launches the downloaded application, selects a user registration function on a home screen, and inputs user data on a screen displayed by the user registration function. As a result, the user is registered to the service by the management computer 18. Data to be registered includes a user ID and a password, for example. In addition, the management computer 18 requires the user to upload a copy of the driver's license of the user himself or herself, for example, for completing user registration.

### Reservation for Car Sharing Service

In operation to request a use of the car sharing service, the user may directly go to the service establishment 12. Alternatively, the user may use the user terminal 22 to make a reservation for the car sharing service. In this case, the user launches the car sharing application, and selects a reservation function on the home screen. Then, on a displayed reservation screen, the user identifies themself using the user ID or the like, inputs a vehicle type, utilization starting time, utilization ending time, and other items. When a vehicle that matches the input items is available, the fee for using the vehicle is displayed on the reservation screen. If the user agrees with the fee, the user enters a reservation confirming input to complete the reservation. Then, the reservation is registered in the management computer 18.

### Fee Scheme

Here, for the electric vehicle 10, in addition to an ordinary fee based on the length of utilization time, the travel distance, and other factors, it is necessary to consider a fee that is charged depending on the change in SOC of the on-board battery 30. For example, a fixed plan and an SOC indexed plan are prepared for the fee associated with the SOC. In the fixed plan, the fee is charged regardless of the SOC. In this case, a battery recharge card is lent to the user for allowing the user to recharge the on-board battery 30 using the battery recharge card at predetermined recharging facilities at no additional cost.

In the SOC indexed plan, on the other hand, the SOC at the start of utilization is compared with the SOC at the end of utilization, and the fee is adjusted based on the resulting difference between the SOC values. For example, a unit price per electric power is defined to be approximately 20 to 50 yen/1 kWh, and a value obtained by multiplying the difference between the SOCs by the unit price is determined as a fee for a variation in the SOC.

### Discount by Recharging Operation

Here, in this embodiment, when the on-board battery 30 is recharged by a user, a recharge point is given to the user, and a discount on the fee is offered to the user depending on the number of recharge points awarded. Because the fee can be discounted by performing a recharging operation, the user is motivated to recharge the battery.

### (i) Recharge Point

In this embodiment, a history of recharging operations is stored in the recharging operation storage 44. The recharging operation storage 44 stores data as to which amount of electric energy is recharged under what condition. Wattage (power) at recharging, an amount of recharging energy (Wh), an amount of recharged electricity (Ah), and a length of recharging time (h), for example, are stored.

Therefore, the management computer 18 acquires, from the electric vehicle 10, information on the recharging operation when the electric vehicle 10 is returned. Then, it becomes possible to recognize, from the acquired information, conditions of the recharging operation performed while the electric vehicle 10 is being utilized by the user.

In this embodiment, one or more recharge points are given to the user every time the user performs the recharging operation, and a user fee may be discounted depending on the number of recharge points accumulated. For example, a number of recharge points, for example 1 point, may be awarded to the user each time they recharge the vehicle with a certain amount of electric power, such as 1 kWh or more.

The number of recharge points (discount rate) awarded may be adjusted depending on factors such as the amount of recharged electricity (Ah), the amount of recharging energy (Wh), the length of recharging time, for example. In consideration of the SOC which corresponds to the amount of recharged electricity (Ah), the discount rate may be determined from the amount of recharged electricity. Alternatively, the discount rate may be determined from the length of recharging time in consideration of a relationship that the amount of recharged electricity is proportional to the length of recharging time in the recharging operation with the same amount of recharging energy. Meanwhile, the time required for the recharging operation is recognized as time that is spent on activity other than driving, which is the main reason the user borrows the vehicle. Based on this recognition, the discount rate may be determined based on the length of time of the recharging operation, irrespective of the amount of recharged electricity.

The SOC of the on-board battery 30 may be estimated from the travel distance (from the start to the end of utilization) traveled by the user, this travel distance being stored in the travel distance storage 46. For example, a relationship of 1 kWh of electric energy=10 km of travel is previously defined. Then, the present SOC expected to be obtained when no recharging operation is performed (or the consumption of electricity corresponding to the travel distance) may be predicted from the travel distance. Following this, the amount of recharged electricity may be estimated from a difference between the expected present SOC and the SOC which is obtained at the end of utilization. For example, assuming that the SOC at the start of rental is 60%, the SOC calculated from the travel distance is −120% (that is, electric energy corresponding to 180% of the SOC is consumed), and the SOC at the time of return is 70%, it is found that the battery is recharged with electricity equivalent to an SOC value of 190%=70%−(−120%). Here, the amount of recharged electricity (electric energy Ah) can be calculated by multiplying 190% by a full battery capacity.

In the fixed plan, the recharge point is also given to the user depending on the amount of recharged electricity. In the SOC indexed plan, this recharge point is given to the user independently of the fee corresponding to the SOC difference.

Awarding recharge points to the user based on their operations to recharge the on-board battery 30 in this manner encourages the user to perform the recharging operation. This can, in turn, help maintain the SOC of the on-board battery 30 within an appropriate range. When the recharging operation is performed at a private home, for example, the recharging operation can be performed overnight with electric power that is purchased at a reduced, late night rate. Thus, the recharging operation at home is beneficial in cost in light of the SOC indexed fee in the SOC indexed plan which is usually defined at a higher price for rapid recharging or the like. In addition, the discount rate may be adjusted depending on a time period in which the recharging operation is performed. Not only is late night electric power available at a lower price, but using late night electric power is also recommendable in terms of leveling of general power consumption. In this regard, when a greater discount rate is offered in connection with the recharging operation using the late night electric power, utilization of the midnight electric power by the user can be further promoted.

On the other hand, in a case where there is a desire to promote a recharging operation during a time period when electricity rates are higher, recharge points may be additionally offered to users who perform the recharging operation in a time period, such as daytime, when lower-cost late night electricity rates are not available. In this way, the recharging operation during daytime can be promoted.

Meanwhile, an on-board battery 30 that is recharged with low electric power for standard recharging will likely have a longer operable lifetime than one that is rapid charged with high electric power. With this in view, the condition under which the on-board battery 30 is recharged may be stored, and a recharge point may be awarded to a user who performs a standard recharging operation, for example.

### (ii) Point for Increased SOC

When the SOC at the end of utilization is increased from the SOC at the start of utilization, a corresponding recharge point may be offered.

The recharge point in this example is offered in both the fixed plan and the SOC indexed plan.

(iii) Point for Suitable SOC

When the SOC at the end of utilization has a value suitable for next rental (in a predetermined suitable range) from 60% to 80%, for example, a recharge point is offered.

The recharge point in this example is offered in both the fixed plan and the SOC indexed plan.

Because the SOC may have adverse effects when it approaches 0% or 100%, the SOC may be defined to be in a range from 10% to 90%, or in a range of 20% to 80%. In particular, in the electric vehicle 10, because a greater amount of energy can be recovered as the number of uses of regenerative braking is increased, a rechargeable upper limit of the SOC may be set to approximately 80%.

### Procedure for Awarding Recharge Points

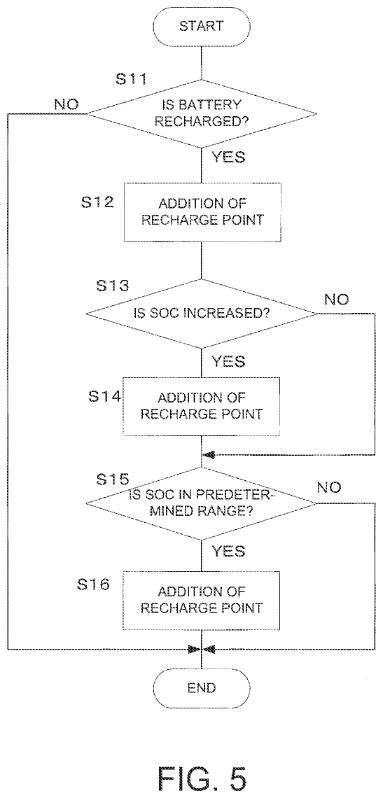

FIG. 5 is a flowchart showing a procedure for awarding a recharge point. Recharge points may be awarded as the car sharing service is being utilized, or may be offered at the time of payment of the car sharing service fee after utilization of the carsharing service is ended. Hereinafter, the procedure is explained with respect to an example of offering one recharge point at the end of the car sharing service.

Initially, it is determined whether the battery was recharged during utilization of the car sharing service (step S11). When Yes is determined, the recharge point is added (step S12). When No is determined in step S11, operation is terminated because there is no point to be awarded.

Then, the present SOC is compared with the SOC at the start of utilization of the service to determine whether the present SOC is increased (step S13). When the present SOC is increased, the recharge point is added (step S14). When No is determined in step S13, step S14 is skipped. Following addition of the recharge point in step S14 or when No is selected in step S13, it is determined whether the present SOC (the SOC at the end of utilization) is an appropriate SOR (step S15). When Yes is determined, the recharge point is added (step S16), and operation is terminated. When No is determined in S15, operation is also terminated.

### Notification of Discount Information

### (i) Notification at Start of Utilization

At the start of utilization of the car sharing service, when the electric vehicle 10 is switched on and an instruction to start utilizing the car sharing service is input, processing to start the utilization is initiated. Alternatively, it may be previously specified that utilization of the car sharing service is started in response to an action of switching on the electric vehicle 10 again after the electric vehicle 10 is switched on. Alternatively, the instruction to start the utilization of the far sharing service may be issued from the management computer 18.

First, the states of the recharging operation storage 44, the travel distance storage 46, and the fee calculator 48 are initialized. Previously stored data may be transferred to another location and stored therein, or may be cleared. The SOC of the on-board battery 30 is stored as an initial SOC in the recharging operation storage 44. Further, the travel distance of the electric vehicle 10 at the start of utilization is stores as an initial value in the travel distance storage 46.

Whether a usage plan is specified is inquired by mans of the navigation device, and when a response indicating that the usage plan is specified is obtained, a planning screen is displayed. On the planning screen, a destination, a stopover, a location to end utilization of the service, etc. are input. Of course, the user may input just their first destination, or may input no destinations at all.

Then, information is presented notifying the user that the above-described four types of recharge points are available. When the destination or other locations are specified, the navigation device performs a search for appropriate recharging facilities available on the route to the destination or locations, and displays the recharging facility when it is found as a result of the search, along with a notification of a recharge point to be offered at the recharging facility.

### (ii) Notification During Travel

Once travel is started, the SOC is monitored, and notifications of an available recharging facility found from map data are presented as appropriate. In a case where a route is specified, a user is notified when the vehicle approaches a recommendable recharging facility which has been initially found. If the vehicle travels past the recommendable recharging facility without being recharged, a next recharging facility is subsequently selected and a notification presented. On the other hand, during travel of the vehicle in which no route has been specified, the user may be notified of an approaching recharging facility when the SOC falls below a lower limit of the suitable SOC (below 60%, for example).

### Procedure to Guide Route to Recharging Facility

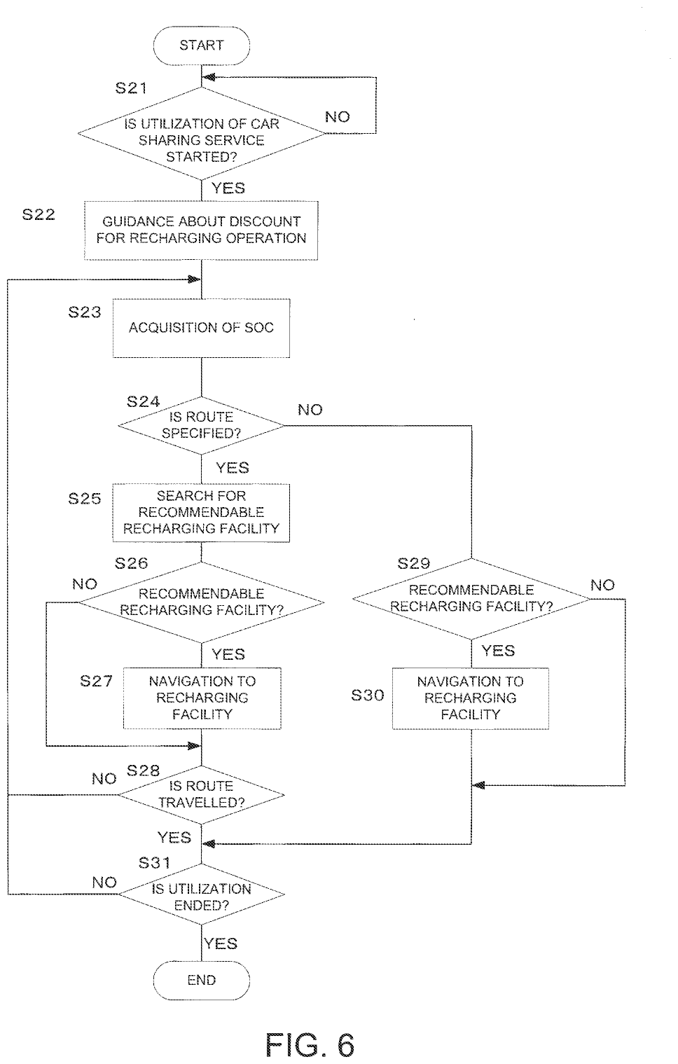

FIG. 6 is a flowchart for explaining a process to guide a route to a recharging facility. Initially, whether utilization of the car sharing service is started is determined (step S21), and when it is determined to be started (Yes is determined in step S21), the process to guide the route is initiated. It should be noted that after Yes is determined in step S21, the electric vehicle 10 is in a movable state, and starts traveling as appropriate.

At the start of utilization of the car sharing service, discount information about the recharging operation is initially notified (step S22). For example, a brief explanation about the recharge point, the point for the increased SOC, and the point for the suitable SOC is presented. The explanation may be output as a speech, or may be displayed on a display. Because the navigation device of the electric vehicle 10 is typically activated at the start of the electric vehicle 10, and a notification of activation of the navigation device is accordingly output, the discount information about the recharging operation may be added to the notification of activation.

After output of the notification is completed, the present SOC of the on-board battery 30 is acquired (step S23). Then, whether a route is specified is determined (step S24).

When the route is specified, future values of the SOC are predicted from the present SOC, and recharging facilities on the specified route are searched to find, based on the predicted values of the SOC, a recharging facility which is recommended to be used (a recommendable recharging facility) in terms of the SOC (step S25). Then, it is determined whether the vehicle approaches the recommendable recharging facility found from the search (step S26). When Yes is determined in step S26, the vehicle is navigated to the recommendable recharging facility (step S27). After navigation in step S27 is completed, or when No is determined in step S26, it is determined whether traveling on the specified route is completed (step S28), and when No is determined, operation returns to step S23 to acquire the present SOC.

When No is determined in step S24; i.e., when no route is specified, it is determined whether there is an approaching recharging facility which is recommended to be used for the recharging operation in terms of the present SOC (step S29). When Yes is determined in step S29, the vehicle is navigated to the recharging facility (step S30). After the navigation in step S30 is completed, or when No is determined in step S29, or when Yes is determined in S28; i.e. traveling on the specified route is completed, it is determined whether utilization of the car sharing service is finished (step S31). When the utilization is not finished, operation returns to step S23 to repeat the process steps. On the other hand, when Yes is determined in step S31, operation is terminated.

1. A car sharing fee system for calculating a car sharing fee of an electric vehicle, wherein
the car sharing fee system is configured to discount the car sharing fee when the electric vehicle is recharged by a user.

2. The car sharing fee system according to claim 1, comprising:
a recharging operation storage configured to store at least one of an amount of recharged electricity and a length of recharging time, wherein
the car sharing fee system is configured to discount the car sharing fee based on the at least one of the amount of recharged electricity and the length of recharging time.

3. The car sharing fee system according to claim 2, further comprising:
a travel distance storage configured to store a travel distance; and
a recharged amount calculator configured to estimate from the travel distance a present state of charge that is expected to be found when no recharging operation is performed, and calculate the amount of recharged electricity from a difference between the expected present state of charge and an actual state of charge, wherein
the car sharing fee system is configured to discount the car sharing fee based on the calculated amount of recharged electricity.

4. The car sharing fee system according to claim 1, wherein
the car sharing fee system is configured to discount the car sharing fee when a state of charge found at return of the electric vehicle is in a predetermined range.

5. The car sharing fee system according to claim 1, wherein
the car sharing fee system is configured to discount the car sharing fee when the electric vehicle is recharged to a predetermined state of charge.

6. The car sharing fee system according to claim 1, wherein
the car sharing fee system is configured to change a rate of discounting the car sharing fee depending on a time period in which a recharging operation is performed.

7. The car sharing fee system according to claim 1, further comprising:
an output unit configured to notify information about discounting of the car sharing fee.
